(19) United States
(12) Patent Application Publication
(10) Pub. No.: US 2018/0074658 A1
(43) Pub. Date: Mar. 15, 2018

(54) SYSTEM AND METHODS FOR ON-SCREEN KEYBOARD

(71) Applicants: Hisense USA Corp., Suwanee, GA (US); Hisense Electric Co., Ltd., Qingdao (CN); Hisense International Co., Ltd., Qingdao (CN)

(72) Inventor: Roger J. STRINGER, Suwanee, GA (US)

(73) Assignees: Hisense USA Corp., Suwanee, GA (US); Hisense Electric Co., Ltd., Qingdao (CN); Hisense International Co., Ltd., Qingdao (CN)

(21) Appl. No.: 15/262,673

(22) Filed: Sep. 12, 2016

(51) Int. Cl. G06F 3/0482; G06F 3/0484; G06F 3/033

(52) U.S. Cl. CPC G06F 3/0482; G06F 3/033; G06F 3/04845

(57) ABSTRACT

The present disclosure relates to on-screen keyboard presentation and device control. In one embodiment, a process includes presenting an on-screen keyboard including a plurality of character display zones, wherein each character display zone of the plurality of character display zones is presented with a display position representing a directional input and each character display zone includes a plurality of characters. The process can also include detecting a directional command from a control device to select a character display zone, and updating presentation of the on-screen keyboard to highlight a selected character display zone, wherein updating is in response to the directional command from the control device. The process can also include detecting a selection of the selected character display zone, and updating presentation of the on-screen keyboard and display of a character selection box based on the selection of the selected character display zone.

### FIELD

The present disclosure relates to device control, and in particular, display device control including presentation of an on-screen keyboard and detection of control inputs.

### BACKGROUND

Display devices (e.g., TVs) allow for presentation of content to multiple users. More recently, display devices have been provided additional capabilities with respect to providing content. By way of example, the traditional use of viewing broadcast content from over the air sources and cable providers is only a subset of the functionality provided by display devices today. With added functionality, interaction and control of display devices is important for device operation. There exists a need for improved control and operation of devices due to the increased functional ability of display devices.

There also exists a need for improved character input and device operation with respect to text entry. Conventional display device configurations and user interfaces often utilize a grid based display for characters. These configurations are often unsatisfactory due to the number of input commands required to select characters. Although alternative methods exist for operation of a display device, such as mobile device pairing, there exists a need for control of a device with remote controls that addresses difficulties of character selection. Accordingly there exists a need for improved and different control.

### BRIEF SUMMARY OF THE EMBODIMENTS

Disclosed and claimed herein are systems, methods and devices for on-screen keyboard presentation and device control. In one embodiment, a method for on-screen keyboard presentation and device control includes presenting, by a device, an on-screen keyboard including a plurality of character display zones, wherein each character display zone of the plurality of character display zones is presented with a display position representing a directional input and each character display zone includes a plurality of characters. The method also includes detecting, by the device, a directional command from a control device to select a character display zone, and updating, by the device, presentation of the on-screen keyboard to highlight a selected character display zone, wherein updating is in response to the directional command from the control device. The method also includes detecting, by the device, a selection of the selected character display zone, and updating, by the device, presentation of the on-screen keyboard and display of a character selection box based on the selection of the selected character display zone.

In one embodiment, the plurality of character display zones are presented in non-overlapping positions and separated from each other such that the display position of each character display zone correlates to major directional inputs of the control device.

In one embodiment, the directional command from a control device is one of a left, right, up and down directional command.

In one embodiment, updating presentation of the on-screen keyboard to highlight a selected character display zone includes modifying position of a selection element with respect to a selected character display zone.

In one embodiment, updating presentation of the on-screen keyboard to highlight a selected character display zone includes presenting a second level configuration including a single character display zone.

In one embodiment, updating presentation of the on-screen keyboard and display of a character selection box based on the selection includes displaying a selected character in the character selection box of the on-screen keyboard.

In one embodiment, the method also includes detecting, by the device, directional commands for updating highlighting within a character display zone and updating the display of the character display zone based on the directional display commands to move a selection element.

In one embodiment, the method also includes receiving a character set and determining character presentation format for the plurality of character display zones of the on-screen keyboard.

In one embodiment, the method also includes updating character presentation format based on selections of the on-screen keyboard.

In one embodiment, the method also includes updating at least one of the character display zones and characters displayed with the on-screen keyboard based on character selections.

According to another embodiment, a device is provided including a display and a controller configured to control the display. The controller is configured to present an on-screen keyboard including a plurality of character display zones, wherein each character display zone of the plurality of character display zones is presented with a display position representing a directional input and each character display zone includes a plurality of characters. The controller is also configured to detect a directional command from a control device to select a character display zone, and update presentation of the on-screen keyboard to highlight a selected character display zone, wherein updating is in response to the directional command from the control device. The controller is also configured to detect a selection of the selected character display zone and update presentation of the on-screen keyboard and display of a character selection box based on the selection of the selected character display zone.

According to another embodiment, a system is provided including a control device and a display device. The display device is configured to present an on-screen keyboard including a plurality of character display zones, wherein each character display zone of the plurality of character display zones is presented with a display position representing a directional input and each character display zone includes a plurality of characters. The display device is also configured to detect a directional command from the control device to select a character display zone and update presentation of the on-screen keyboard to highlight a selected character display zone, wherein updating is in response to the directional command from the control device. The display device is also configured to detect a selection of the selected character display zone, and update presentation of the on-screen keyboard and display of a character selection box based on the selection of the selected character display zone.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of an on-screen keyboard according to one or more embodiments;

FIG. 2 depicts a process for on-screen keyboard presentation according to one or more embodiments;

FIG. 3 depicts a graphical representation of a device according to one or more embodiments;

FIG. 4 depicts on-screen keyboard presentation according to one or more other embodiments;

FIG. 5 depicts on-screen keyboard presentation according to one or more embodiments;

FIG. 6 depicts characteristics of an on-screen keyboard according to one or more embodiments; and

FIG. 7 depicts a process for on-screen keyboard presentation according to one or more embodiments.

### DETAILED DESCRIPTION OF THE EXEMPLARY EMBODIMENTS

Overview and Terminology

One aspect of the disclosure is directed to control configurations for a device and, in particular, to controls and operations for character selection by way of an on-screen keyboard. Devices, such as display devices, are often configured to be controlled with a control device (e.g., remote control, etc.). Methods and device configurations discussed herein provide advances to conventional control methodologies and improve device performance. One embodiment is directed to a process for presentation of an on-screen keyboard with a plurality of character display zones. The control configurations discussed herein can leverage the functionalities of control devices and improve device performance by reducing the number of commands required to obtain a user selection, providing faster access to functionality, improving search and overcoming limitations associated with use of a device.

In one embodiment, a device is provided including a control configuration for presentation and operation based on an on-screen keyboard. Another embodiment is directed to a system including a display device and a control device.

As used herein, an on-screen keyboard relates to presentation of a plurality of characters (e.g., text, symbols, etc.) which can be selected for operation of the display device.

As discussed herein, applications relate to programs operating on a device. The programs may be part of the operating platform of the device and may be accessed by a user. Applications of the device may each be associated with a particular purpose. By way of example, the device may include applications for web browsing, communications (e.g., phone, messaging, email, etc.), capturing image data, social media, widgets, etc.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

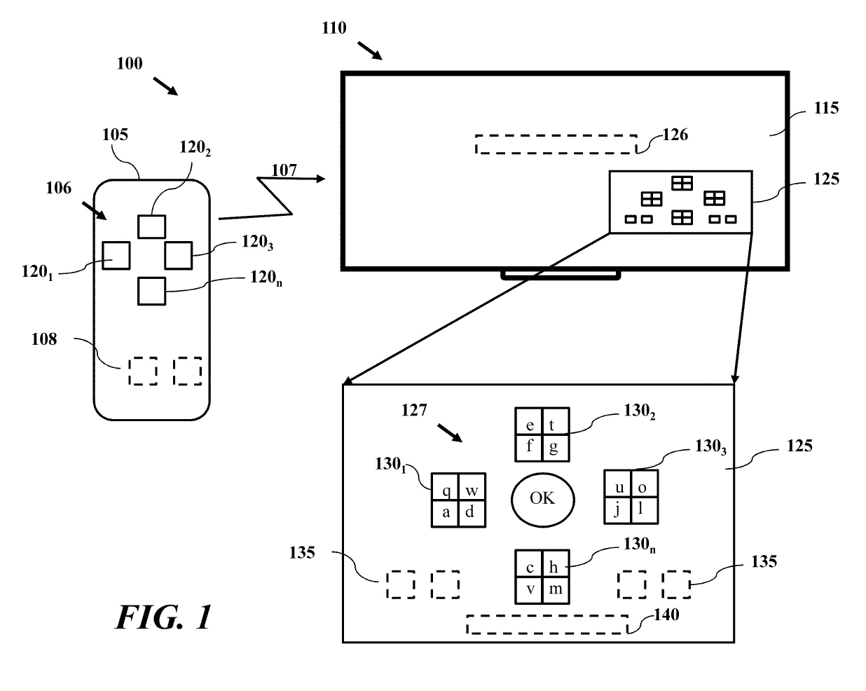

Referring now to the figures, FIG. 1 depicts a graphical representation of an on-screen keyboard according to one or more embodiments. FIG. 1 depicts system 100 including control device 105 and device 110. According to one embodiment, device 100 includes display 115 and is configured to present an on-screen keyboard 125 to allow for control of device 110. In particular, control can include selection and/or input of text characters by way of control device 105 and on-screen keyboard 125. In one embodiment, on-screen keyboard 125 allows for characters, text, and symbols to be selected and utilized by device 110. On-screen keyboard 125 may beneficially allow for characters and text to be input using directional inputs of control device 105 and with faster entry than conventional methods of character input. According to one embodiment, presentation of on-screen keyboard 125 may part of a user interface and/or presented in association with one or more applications of device 100. By way of example, on-screen keyboard 125 may be presented when a text box 126 is available for an application executed by device 110.

In one embodiment control device 105 relates to a remote control including a directional input 106. In one embodiment, directional input 106 include buttons 120₁₋ₙ for major input directions (e.g., up, down, left and right). According to another embodiment, directional input and buttons 120₁₋ₙ may be configured as a directional pad to allow for other directional input such as diagonal directions (e.g., up and left, up and right, down and left, and down and right). Based on user input such as button presses of buttons 120₁₋ₙ control device 105 is configured to transmit a command or input, shown as 107, to device 110. In certain embodiments, control device 105 includes optional inputs 108 for interaction with a user interface presented on display 115 of device 110.

According to one embodiment, device 110 may be configured to present content, a user interface, applications and/or one or more functions based on detected control commands. According to another embodiment, device 110 may be configured to present on-screen keyboard 125 to allow for character input and/or selection for one or more of a user interface, applications and/or display functions. In one embodiment, device 110 is a non-touch screen device. In other embodiments, device 110 may relate to a device configured for wireless control from a distance by control device 105. Device 110 may be configured to receive commands 107 from device 105 and interpret the directional button selected to generate the command.

FIG. 1 depicts an exemplary representation of on-screen keyboard 125. As will be discussed in more detail below, presentation of an on-screen keyboard by a device, such as device 110, may be modified based on selections and/or interaction with the on screen keyboard. According to another embodiment, presentation of on-screen keyboard 125 can include presentation for one or more levels. In one embodiment, on-screen keyboard 125 can be presented in a top level configuration 127 including a plurality of character display zones 130₁₋ₙ. In one embodiment, each of the plurality of character display zones 130₁₋ₙ are presented with a display position representing a direction command. By way of example, character display zone 130₁ represents a left direction (e.g., 120₁), character display zone 130₂ represents up (e.g., 120₂), character display zone 130₃ represents right (e.g., 120₃) and character display zone 130ₙ represents down (e.g., 120ₙ). According to one embodiment, character display zones 130₁₋ₙ are presented with a display position associated with a directional layout associated with control device 105. In certain embodiments directional input 106 is a single unit configured to detect one or more directions including presses (e.g., single, multiple, etc.) and holds in major directions such as up, down, left right and also diagonal directions.

According to another embodiment, each character display zone 130₁₋ₙ includes a plurality of characters. In one embodiment, selection of a directional input of control device 105 is transmitted as a directional command 107 to device 110 and a selection element is then presented with the corresponding character display zone. By way of example, selection of left direction (e.g., 120₁) will result in a selection element being presented in character display zone 130₁. In that fashion, device 110 updates presentation of the on-screen keyboard 125 to highlight a selected character display zone. Within a selected character display zone, one or more directional commands may be received to move the selection element to a desired character or symbol.

Device 110 is configured to detect inputs for selection of the selected character display zone, navigation within a selected character display zone, navigation within on-screen keyboard 125 and commands relative to on-screen keyboard 125. Based on input detected, device 110 can control operation. As will be discussed in more detail below, device 110 can update presentation of the on-screen keyboard 125 and display of a character selection box based on the selection of the selected character display zone. In one embodiment, on-screen keyboard 125 may optionally includes one or more of optional graphical elements 135 which may be selected to update presentation of on-screen keyboard 125. By way of example, optional graphical elements 135 may be accent level elements on-screen keyboard 125 which may be selected to change character case, a character set, symbols, etc. In one embodiment, optional graphical elements 135 may be selected based on optional inputs 108 of control device 105.

Device 110 may be configured to present on-screen keyboard 125 on display screen 115 in one or more locations of screen display 115. In one embodiment, presentation of on-screen keyboard 125 presented with optional text entry box 140. As will be discussed in more detail below, the device 110 may update the display configuration of on-screen keyboard 125 based on one or more received commands.

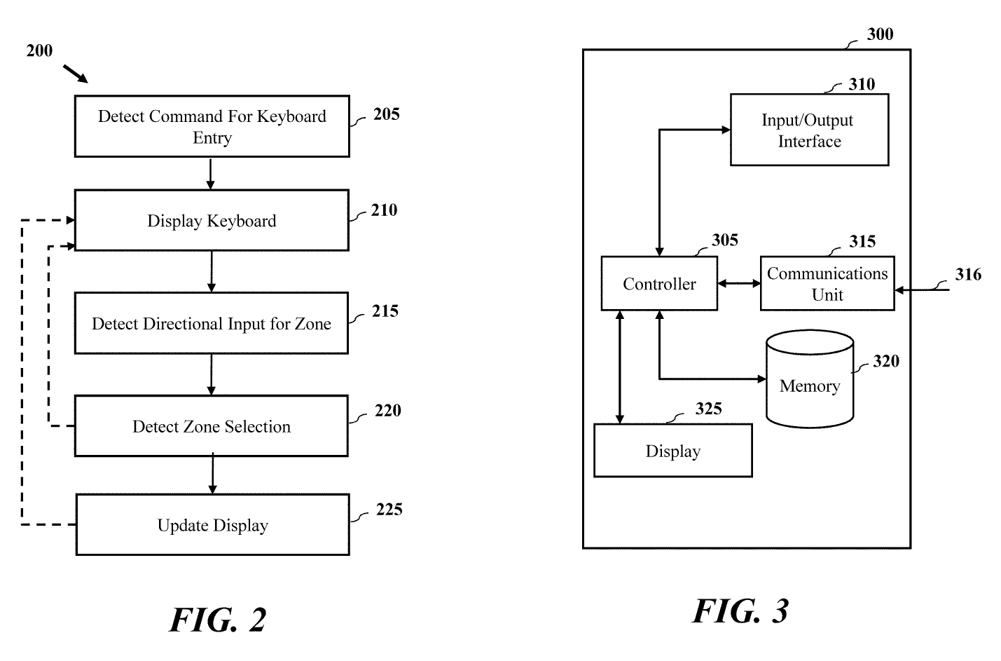

FIG. 2 depicts a process for presentation of an on-screen keyboard according to one or more embodiments. According to one embodiment, process 200 may be employed to allow for character selection and user control of a device (e.g., device 110) in response to commands from a control device (e.g., control device 105). Process 200 may be employed by a device (e.g., device 110), such as a display device. In certain embodiments, process 200 may be employed for non-touch screen display devices. Process 200 may reduce the number of commands required to access and select characters for character entry. In addition, process 200 can reduce the need for alpha numeric keys on a remote control and can add functionality to remote controls that include directional pads.

In one embodiment, process 200 is initiated at block 205 with detecting a command for keyboard entry at block 205. In certain embodiments, presentation of an on-screen keyboard may be associated with an application or function of a device (e.g., device 110) which requires character selection, a search box, and/or text entry. Exemplary operations for presentation of an on-screen keyboard include keyword search, device configurations, device personalization, content search and device operation in general. In certain embodiments, presentation of an on-screen keyboard is associated with presentation of a text box by a display device and/or application of the display device. Commands detected at block 205 for keyboard entry may be generated by a control device (e.g., control device 105), display device (e.g., device 110) and/or an application executed by a device. According to another embodiment, presentation of an on-screen keyboard at block 205 may be based on receiving a character set and determining character presentation format for the plurality of character display zones of the on-screen keyboard.

At block 210, process 200 includes display of an on-screen keyboard. In one embodiment, display of on-screen keyboard includes presentation of a plurality of character display zones. According to another embodiment, each character display zone of the on-screen keyboard is presented with a display position representing a directional input and each character display zone includes a plurality of characters. At block 210, the plurality of character display zones are presented in non-overlapping positions and separated from each other such that the display position of each character display zone correlates to major directional inputs of the control device. According to one embodiment, presentation of an on-screen keyboard at block 210 relates to a top level format for the on-screen keyboard.

In one embodiment, presenting character display zones of the on-screen keyboard is presented with a display position representing a directional input includes presentation of the character display zones in different positions (see FIG. 1, for example). According to another embodiment, each character display zone includes a partition or sample set of characters from a character set. In one embodiment, character display zones are presented based on fixed character sets. In other embodiments, character display zones are presented based on dynamic character sets which allows for available characters to be modified.

At block 215, process 200 includes detection of one or more directional input signals to select a character display zone. At block 215, a directional command from a control device is one of a left, right, up and down directional command. Once a character display zone is detected directional commands may be employed to highlight elements within the character display zone and/or exit the character display zone to select other characters from another zone. As such, process 200 can includes detecting directional commands for updating highlighting within a character display zone and updating the display of the character display zone based on the directional display commands to move a selection element.

At block 220, process 200 includes detecting a selection associated with a character display zone. In one embodiment, a selection relates to selection of a highlighted character and may be based on selection command generated by a control device. In one embodiment, updating presentation of the on-screen keyboard at block 220 includes modifying position of a selection element with respect to a selected character display zone. According to another embodiment, updating presentation of the on-screen keyboard at block 220 includes presenting a second level configuration including a single character display zone. In certain embodiments, following a selection at block 220, process 200 may return to display of the keyboard at block 210. In other embodiments, process 200 may update presentation of the on-screen keyboard at block 225 following a selection at block 220.

In block 225, process 200 includes detecting a selection of the selected character display zone, and updating presentation of the on-screen keyboard and display of a character selection box based on the selection of the selected character display zone. In one embodiment, updating display of the on-screen keyboard at block 225 may be based on a character selection for one or more of updating characters available for selection in each character display zone, updating the presentation format of the on-screen keyboard, changing keyboard level and/or modifying character display zones based on accent level selections. Updating at block 225 can include, updating character presentation format based on selections of the on-screen keyboard. Updating at block 225 can include, updating at least one of the character display zones and characters displayed with the on-screen keyboard based on character selections. In block 225, process 200 can display a selected character in the character selection box of the on-screen keyboard. In certain embodiments, following a selection at block 225, process 200 may return to display of the keyboard at block 210.

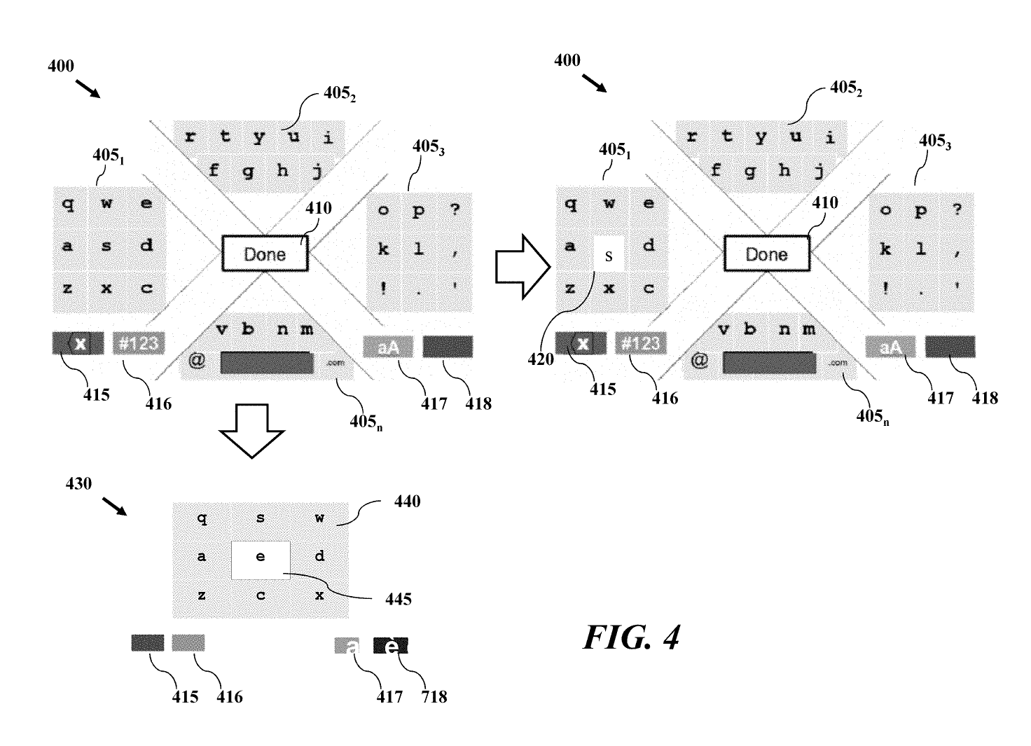

FIG. 3 depicts a graphical representation of a device according to one or more embodiments. According to one embodiment, device 300 is a display device and is configured for presentation of an on-screen keyboard presentation. FIG. 3 depicts a representation of elements of a device, such as device 110 of FIG. 1 according to one or more embodiments. Device 300 includes controller 305, input/output (I/O) interface 310, communications unit 315, memory 320 and display 325. Controller 305 may communicate with each of user interface 310, communications unit 315, memory 320 and display 325 by way of one or more communication links within device 300.

Device 300 includes controller 305 configured to control presentation of content on display 325 and for control by way of input/output (I/O) interface 310 and communications unit 315. According to certain embodiments, controller 305 may be configured to detect a command to for keyboard entry. The command may be generated by an application executed by device 300 and/or presentation of content including a text box or allowing for character selection and entry. Controller 305 is also configured to detect commands 316 received by communications unit 315.

Controller 305 may be configured to execute code stored in memory 320 for operation of device 300 including presentation of a graphical user interface, overlay windows, graphical elements, etc. Controller 305 may include a processor and/or one or more processing elements. In one embodiment controller 305 may be include one or more of hardware, software, firmware and/or processing components in general. According to one embodiment, controller 305 may be configured to perform one or more processes described herein.

Input/output (I/O) interface 310 may function to present graphic elements for control of device 300. Communications unit 315 may be configured to allow for transmission and reception of data relative to device 300. Communications unit 315 may be configured for wired and/or wireless communication with one or more network elements, such as servers. Memory 320 may be configured to store data captured by device 300 and to store instructions for operation of device 300. Memory 320 may include non-transitory RAM and/or ROM memory for storing executable instructions, operating instructions and content for display.

FIG. 4 depicts on-screen keyboard presentation according to one or more other embodiments. On-screen keyboard 400 is depicted including character display zones 405₁₋ₙ. According to one embodiment, characters within the character display zones 405₁₋ₙ may be highlighted and/or selected using directional commands of a control device (e.g. control device 105). According to one embodiment, character display zones 405₁₋ₙ contains up to 9 characters. In addition, each character display zones 405₁₋ₙ may include a uniform presentation format with characters presented in a similar grid format (3×3 grid, etc.), or may include a presentation format wither multiple grid formats.

On-screen keyboard display 400 includes button 410 labeled ‘done’ which may be highlighted and selected to end display of on-screen keyboard 400. According to one embodiment, on-screen keyboard 400 includes presentation of graphical elements 415, 416, 417 and 418 which may be highlighted and selected and/or activated based on remote control signals. Graphical elements 415, 416, 417 and 418 may be accent level elements of the on-screen keyboard. In certain embodiments, graphical elements 415, 416, 417 and 418 may be associated with function keys of a control device (e.g., control device 105). According to an exemplary embodiment, graphical element 415 can be configured as a backspace function to delete selected characters, graphical element 416 can be configured to switch alphabetical display to a numerical display, graphical element 417 can be configured to change case of display characters, and graphical element 418 can be configured to access symbols.

FIG. 4 depicts an exemplary representation of navigation within a selected character display zone with highlighting of a selected character shown as 420. According to one embodiment, 405₁ is selected by a left directional input. According to another embodiment, a predefined element within the display zone may be highlighted in response to an initial direction input when a highlight element is not presented. Selection element 420 may represent the first element that is highlighted. In other embodiment the element closest to the center of the (e.g., near done button 410) is the first to be highlighted with a left command. Presentation format of the on-screen keyboard 400 overcomes the series of button presses that are required by conventional selection techniques.

According to one embodiment a device is configured to update presentation of the on-screen keyboard based on selections. Based on a directional command to select character display zones 405₁₋ₙ, selection element 420 may be presented within a character display zone, such as character display zone 405₁, to highlight and/or select characters. In certain embodiments, selection of a character and/or input of a directional command can include updating presentation to a second level format 430 including a plurality of characters 440 and highlight element 445. Second level format 430 can include graphical elements 415, 416, 417 and 418 as accent level elements. In one embodiment second level format 430 is displayed following selection of a display zone and may relate to selection and/or navigation within the character display zone. In other embodiments, second level format 430 relates to a second level following one or more selections of characters.

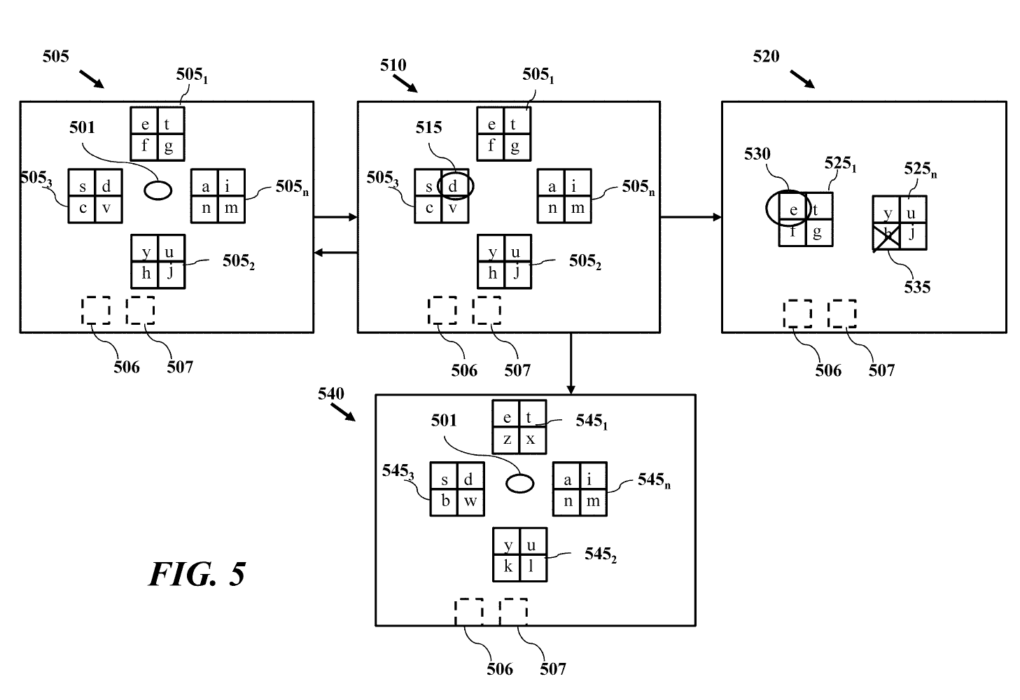

FIG. 5 depicts on-screen keyboard presentation according to one or more embodiments. According to one embodiment, a device is configured to allow for navigation within an on-screen keyboard. According to another embodiment, a device may update presentation of the on-screen keyboard based on navigation commands, on-screen keyboard selections and/or control inputs. FIG. 5 depicts presentation formats of an on-screen keyboard according to one or more embodiments.

According to one embodiment, on-screen keyboard 505 includes a highlight element 501 and a plurality of character display zones 505₁₋ₙ. Highlight element 501 may be displayed initially between character display zones 505₁₋ₙ, the position of which may be updated based on one or more input commands to select a character. In some embodiments, highlight element 501 is not displayed until a directional command is received. On-screen keyboard 505 can optionally include accent level elements 506 and 507. According to one embodiment, a device is configured to update position of highlight element based on directional commands.

On-screen keyboard 510 relates to a top level configuration with a character selected by highlight 515 in character display zone 505₃ (e.g., left display zone). FIG. 5 depicts two exemplary updated formats to the on-screen keyboard. In certain embodiments, election of a character is detected and the device reverts to top-level form a for on-screen keyboard presentation 505. In one embodiment, based on a selection of a character display zone, such as character display zone 505₃, on-screen keyboard 520 may be presented including an updated presentation. Alternatively, on-screen keyboard 540 may be presented following interaction with on-screen keyboard 510.

On-screen keyboard 520 includes character display zones 525₁₋ₙ. According to one embodiment, character display zones 525₁₋ₙ includes a reduced number of characters relative to on-screen keyboard 510. In that fashion, the device may present characters that are relevant to content accessible from a particular search. According to another embodiment, on-screen keyboard 520 includes highlight 530 which may be positioned in character display zone 525₁ based on direction input. According to one embodiment, the device may determine based on the highlight 530 that certain displayed characters will not be applicable to a search based on highlighting of other characters. Accordingly, presentation of on-screen keyboard 520 may including a graphical element 535 indicating applicability of a particular character. In certain embodiments, multiple characters may be marked with elements similar to graphical element 535.

On-screen keyboard 540 may relates to a presentation including a plurality of character display zones 545₁₋ₙ. Based on a previous selection, such as a selection of on-screen keyboard 510 and one or more search string matching, characters presented in on-screen keyboard may be updated such that character display zones 545₁₋ₙ include a different set of characters or elements than character display zones 515₁₋ₙ.

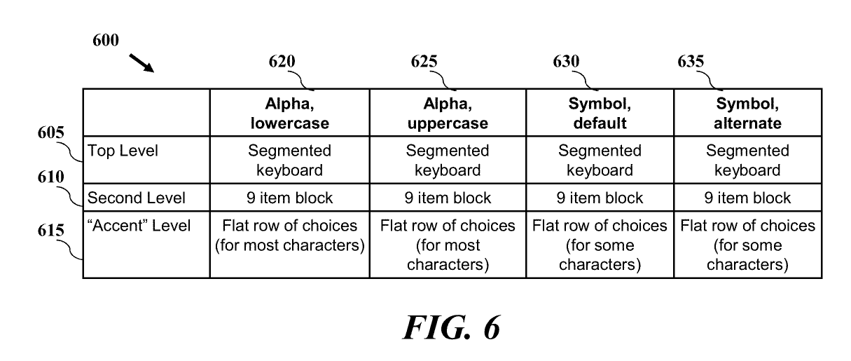

FIG. 6 depicts characteristics 600 of an on-screen keyboard according to one or more embodiments. In one embodiment, presentation of an on-screen keyboard (e.g., on-screen keyboard 125, on-screen keyboard 400, etc.) can include one or more character display zones and formatting for character display zones FIG. 6. According to another embodiment, presentation of the on-screen keyboard can include multiple display levels/formats. By way of example, a top level 605 of the on-screen keyboard relates to the initial presentation level, whereas a second level 610 may relate to a narrowed or more tailored presentation format with targeted and/or reduced selection options. According to yet another embodiment, presentation of an on-screen keyboard can include an accent level 615 or one or more graphical elements that may be presented in addition with the on-screen keyboard. The accent level 615 can be selected to modify character sets and/or format included in the on-screen keyboard.

According to another embodiment, each presentation level or format may be modified during display of the on-screen keyboard. Accordingly, characteristics 600 for presentation can include alphabetical characters formatted in lower case 620, alphabetical characters formatted in uppercase 625, symbols 630, and alternate symbols 635.

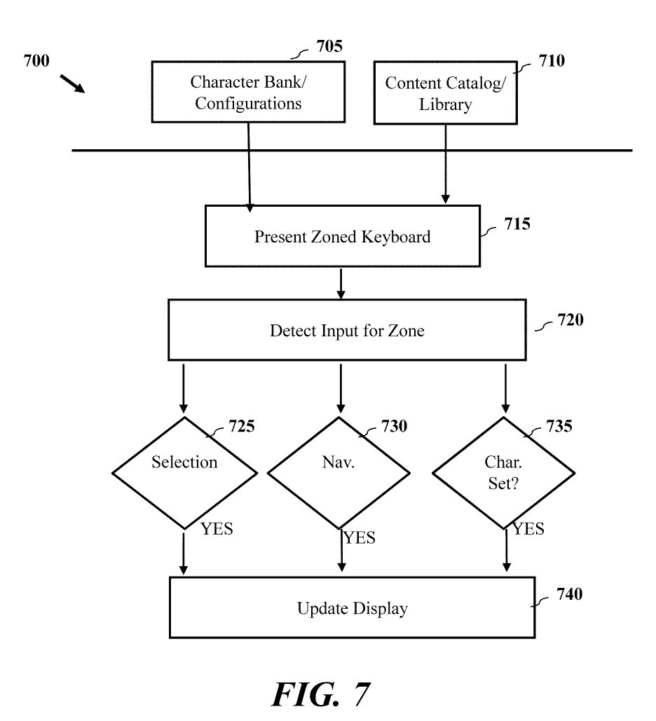

FIG. 7 depicts a process for on-screen keyboard presentation according to one or more embodiments. According to one embodiment, presentation of an on-screen keyboard may be based on one or more character banks/character configurations and/or a content catalog/library. In one embodiment, a display device may store one or more character sets in memory for presentation of an on-screen keyboard. In addition, the device may select one of a plurality of character sets from a character bank/configuration to present an on-screen keyboard. In a similar fashion, character presentation in an on-screen keyboard may be based on keywords or terms available for search. Process 700 includes operations by a device (e.g., device 110) for presentation of an on-screen keyboard. According to one embodiment, ad device may receive one or more character banks at block 705. The device may receive a content catalog/library at block 710 which can include a listing and/or keywords. Based on information received at block 705 and 710, a device may present a zone keyboard at block 715. In one embodiment the zone keyboard at block 715 relates to an on-screen keyboard presentation, such as the on-screen keyboard presentation 125 of FIG. 1.

At block 720 process 700 includes detecting input associated with a character display zone. Based on the detected input, process 700 may determine a selection of the zone at block 725, determine navigation commands at block 730 and identify a character set selection at block 735. Process 700 may then update the display at block 740 based on one or more determinations at block 725, block 730 and block 735. At block 725, for example, one or more characters may be selected and within a character zone. Navigation commands at block 730 may relate to commands within the character display zone and commands to exit the character display zone. At block 735, the device may determine whether characters display in the character display zone should be updated. In that fashion, different keyboard configurations can be provided with fixed and dynamic character sets.

While this disclosure has been particularly shown and described with references to exemplary embodiments thereof, it will be understood by those skilled in the art that various changes in form and details may be made therein without departing from the scope of the claimed embodiments.

What is claimed is:

1. A method for on-screen keyboard presentation and device control, the method comprising:
presenting, by a device, an on-screen keyboard including a plurality of character display zones, wherein each character display zone of the plurality of character display zones is presented with a display position representing a directional input and each character display zone includes a plurality of characters;
detecting, by the device, a directional command from a control device to select a character display zone;
updating, by the device, presentation of the on-screen keyboard to highlight a selected character display zone, wherein updating is in response to the directional command from the control device;
detecting, by the device, a selection of the selected character display zone; and
updating, by the device, presentation of the on-screen keyboard and display of a character selection box based on the selection of the selected character display zone.

2. The method of claim 1, wherein the plurality of character display zones are presented in non-overlapping positions and separated from each other such that the display position of each character display zone correlates to major directional inputs of the control device.

3. The method of claim 1, wherein the directional command from a control device is one of a left, right, up and down directional command.

4. The method of claim 1, wherein updating presentation of the on-screen keyboard to highlight a selected character display zone includes modifying position of a selection element with respect to a selected character display zone.

5. The method of claim 1, wherein updating presentation of the on-screen keyboard to highlight a selected character display zone includes presenting a second level configuration including a single character display zone.

6. The method of claim 1, wherein updating presentation of the on-screen keyboard and display of a character selection box based on the selection includes displaying a selected character in the character selection box of the on-screen keyboard.

7. The method of claim 1, further comprising detecting, by the device, directional commands for updating highlighting within a character display zone and updating the display of the character display zone based on the directional display commands to move a selection element.

8. The method of claim 1, further comprising receiving a character set and determining character presentation format for the plurality of character display zones of the on-screen keyboard.

9. The method of claim 1, further comprising updating character presentation format based on selections of the on-screen keyboard.

10. The method of claim 1, further comprising updating at least one of the character display zones and characters displayed with the on-screen keyboard based on character selections.

11. A device comprising:
a display; and
a controller configured to control the display, wherein the controller is configured to
present an on-screen keyboard including a plurality of character display zones, wherein each character display zone of the plurality of character display zones is presented with a display position representing a directional input and each character display zone includes a plurality of characters;
detect a directional command from a control device to select a character display zone;
update presentation of the on-screen keyboard to highlight a selected character display zone, wherein updating is in response to the directional command from the control device;
detect a selection of the selected character display zone; and
update presentation of the on-screen keyboard and display of a character selection box based on the selection of the selected character display zone.

12. The device of claim 11, wherein the plurality of character display zones are presented in non-overlapping positions and separated from each other such that the display position of each character display zone correlates to major directional inputs of the control device.

13. The device of claim 11, wherein the directional command from a control device is one of a left, right, up and down directional command.

14. The device of claim 11, wherein updating presentation of the on-screen keyboard to highlight a selected character display zone includes modifying position of a selection element with respect to a selected character display zone.

15. The device of claim 11, wherein updating presentation of the on-screen keyboard to highlight a selected character display zone includes presenting a second level configuration including a single character display zone.

16. The device of claim 11, wherein updating presentation of the on-screen keyboard and display of a character selection box based on the selection includes displaying a selected character in the character selection box of the on-screen keyboard.

17. The device of claim 11, further comprising detecting, by the device, directional commands for updating highlighting within a character display zone and updating the display of the character display zone based on the directional display commands to move a selection element.

18. The device of claim 11, further comprising receiving a character set and determining character presentation format for the plurality of character display zones of the on-screen keyboard.

19. The device of claim 11, further comprising updating at least one of the character display zones and characters displayed with the on-screen keyboard based on character selections.

20. A system comprising:
a control device; and
a display device, wherein the display device is configured to
present an on-screen keyboard including a plurality of character display zones, wherein each character display zone of the plurality of character display zones is presented with a display position representing a directional input and each character display zone includes a plurality of characters;
detect a directional command from the control device to select a character display zone;
update presentation of the on-screen keyboard to highlight a selected character display zone, wherein updating is in response to the directional command from the control device;
detect a selection of the selected character display zone; and
update presentation of the on-screen keyboard and display of a character selection box based on the selection of the selected character display zone.
